(19) United States
(12) Patent Application Publication
(10) Pub. No.: US 2022/0024651 A1
(43) Pub. Date: Jan. 27, 2022

(54) An Overcap

(71) Applicant: FUJIFILM Diosynth Biotechnologies U.S.A., Inc., Morrisville, NC (US)

(72) Inventor: Mark Yates, Morrisville, NC (US)

(21) Appl. No.: 17/311,482

(22) PCT Filed: Dec. 12, 2019
(86) PCT No.: PCT/US2019/066092

§ 371 Date: Jun. 7, 2021

Related U.S. Application Data
(60) Provisional application No. 62/779,395, filed on Dec. 13, 2018.

(51) Int. Cl. B65D 41/62; B65D 51/18; B65D 55/08; B65D 55/02

(52) U.S. Cl. CPC B65D 41/62; B65D 51/18; B65D 2251/0078; B65D 55/022; B65D 2251/0015; B65D 55/0818

(57) ABSTRACT

A cap for use with a container is described. In one embodiment, the cap is a protective overcap. In one embodiment, the comprises a groove to receive a protrusion of the container; and at least one compartment having an internal void with a volume sufficient to enclose antennae of the container.

### PRIORITY

The present application is a continuation of and claims the benefit of U.S. Provisional Patent Application No. 62/779,395, filed on Dec. 13, 2018 and entitled “A CAP”, which is incorporated by reference in its entirety.

### FIELD OF THE INVENTION

Embodiments of the present invention relate to the field of caps for containers; more particularly, embodiments of the present invention relate to protective caps for bottles, such as, for example, closed-fill drug storage bottles.

### BACKGROUND

Drug products for administration to humans or animals are required to be handled and packaged under conditions such that they do not become contaminated with substances, including particularly microorganisms, which would render them unsuitable for use. While it is standard practice to sterilize drug products at the final fill-finish stage, in many instances, the fill-finish operation is carried out remotely from or at least non-contemporaneously with, the manufacture of the drug substance. The drug substance is therefore stored after manufacture until required for formulation and/or fill-finish, typically in storage containers (e.g., bottles), which also permit the safe transport of the drug substance to the formulation and/or fill finish facility(ies).

Drug substance is commonly filled into storage containers using one of two mechanisms. The first is the use of so-called open filling, where the storage container is exposed to the surrounding atmosphere which is typically Grade A or equivalent). In such cases, the atmosphere is necessarily strictly controlled, such as by the use of clean hoods or clean rooms, in order to mitigate the risk of contamination. Once filled, the storage bottle can be sealed with a robust closure, such as a screw cap. The second is the use of closed-fill systems, where a sterile fill system is used to provide drug substance to the storage bottle. Typically, the fill system comprises a flexible, disposable feed line, and often a second flexible line to allow gas (typically air, although other gases, such as inert gases, may be employed, to escape from the storage container as it is filled. The flexible lines are cut and sealed when the filling is completed. Such closed-fill systems have the advantage of not requiring the controlled atmosphere. However, while the storage container itself may be sealed with a robust closure, the cutting and sealing of the feed lines typically leaves a small length of the feed lines, referred to herein as an antennae, protruding from the container. These antennae become brittle under low temperature storage conditions required for product stability, and therefore can easily be damaged during storage or transport of the filled containers, thereby potentially compromising the sterility of the drug substance. This is a particular issue where the drug substance is stored at low temperature, such as, for example, −70° C., when the antennae may become brittle.

### SUMMARY

A cap for use with a container, such as a storage or transport container, is described. In one embodiment, the cap is a protective overcap. In one embodiment, the overcap comprises a groove to receive a protrusion of the container; and at least one compartment having an internal void with a volume sufficient to enclose antennae of the container.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIGS. 1-4 illustrate embodiments of a protective cap for 1 L and 2 L polycarbonate containers.

FIGS. 5-8 illustrate embodiments of a protective cap for 2 L Polyethylene Terephthalate Glycol (PETG) containers.

FIG. 9 illustrates a section view of one embodiment of an overcap on a container.

FIG. 10 illustrates one embodiment of an overcap on a container with a tie around the overcap.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Embodiments of the present invention relate to caps, and more specifically to protective caps (e.g., overcaps) for closed-fill drug storage bottles. In one embodiment, the protective cap is for a closed-fill fill drug storage and/or transport container comprising one or more antennae and comprises:

a) a mechanism for attaching the cap to the storage and/or transport container; and

b) an internal void having a volume sufficient to enclose and stabilize antennae of the closed-fill fill storage and/or transport container.

In one embodiment, the mechanism for attaching the cap to the container comprises a groove adapted to engage with a protrusion on the storage container, such as, for example, a rim, or lip, on the container, preferably on a neck of a container comprising such a neck. In one embodiment, the protrusion is formed by the closure of the container, where such closure protrudes from the plane of the neck of the container. In one embodiment, the rim is resiliently-deformable when engaged with the protective cap to enable the rim to become deformed to fit into the groove. In one embodiment in which the rim is resiliently-deformable, the cap is snap-fitted onto the container.

In one embodiment, the internal void is formed of two compartments within the protective cap. In one embodiment, the first compartment is defined by groove used for attaching to the rim of the storage container and a lower surface of one or more protrusions into the void (e.g., a shelf or one or more lugs). In one embodiment, the dimensions of the first compartment are selected such that the protrusions into the void engage with the upper surface of the container closure. In one embodiment, the second compartment is defined by an upper surface of the protrusions into the void, the sides and top of the cap, and is connected to the first compartment by an opening, or passage. The dimensions of the opening and second compartment are selected to allow the antennae to be enclosed within the opening and second compartment.

In one embodiment, the cap comprises two or more sections, preferably two, adapted to reversibly engage with each other to form the cap. In one embodiment, the sections reversibly engage using male and female connectors or interfaces. In one embodiment, the cap comprises two sections coupled together using a zip tie, a cable tie or some other coupling scheme well known in the art such as, for example, a snap-fit means, hook and eye connections, etc. In one embodiment, the sections can be secured in their engaged position using tape, such as adhesive tape, or one or more ties. In addition to tape and ties, other mechanisms of reversible engagement may be used such as, for example, a snap-fit mechanism. When ties are employed, the cap preferably comprises lugs, ridges, a groove, or other area to locate or receive a tie on or in the outer surface of the protective cap.

In one embodiment, the cap engages with the container and/or the closure in a manner that prevents the cap rotating about the axis perpendicular to the closure. In one embodiment, the void of the cap, preferably the first compartment of the void when the cap comprises two compartments, includes teeth or grooves to engage with the closure of the storage container. In one embodiment, if the closure comprises a planar surface, the cap has a surface that engages with a surface of the closure to prevent rotation. In one embodiment, the closure of the storage container comprises one or more ridges on its external side surface, and, the cap has ridges (e.g., teeth, grooves, etc.) that engage with at least one, preferably several, of the ridges on the closure.

In some embodiments where the cap comprises two or more sections, the external surface of the sections comprises a plurality of tabs or lugs (e.g., thumb tabs) to assist with disconnecting the portions of the cap.

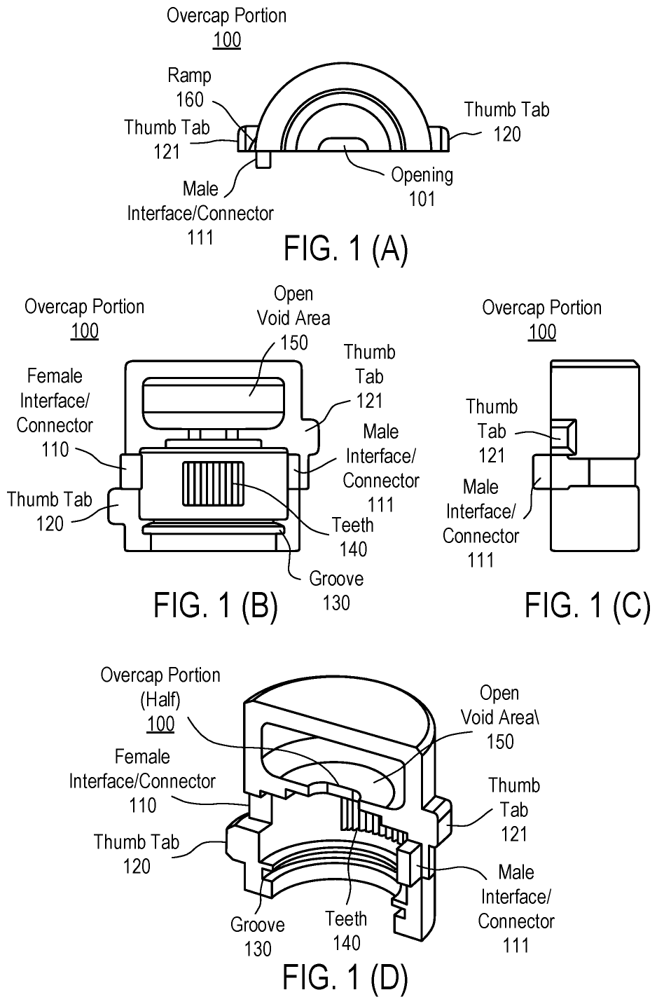

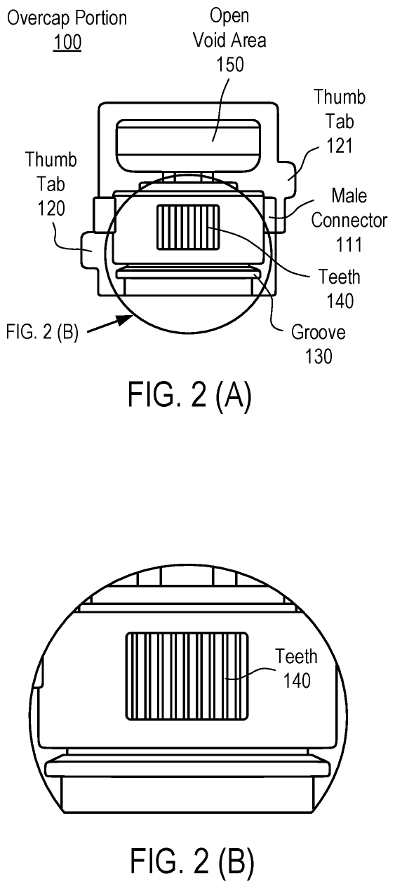

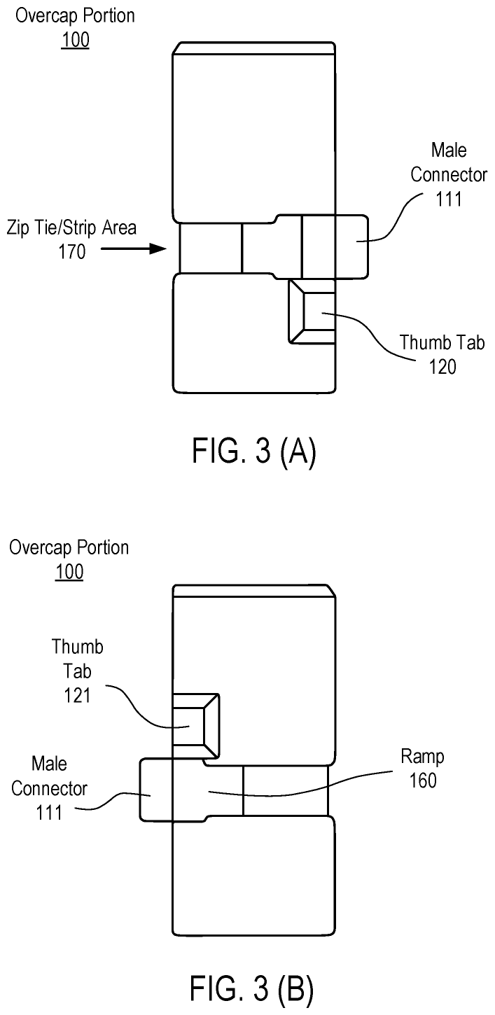

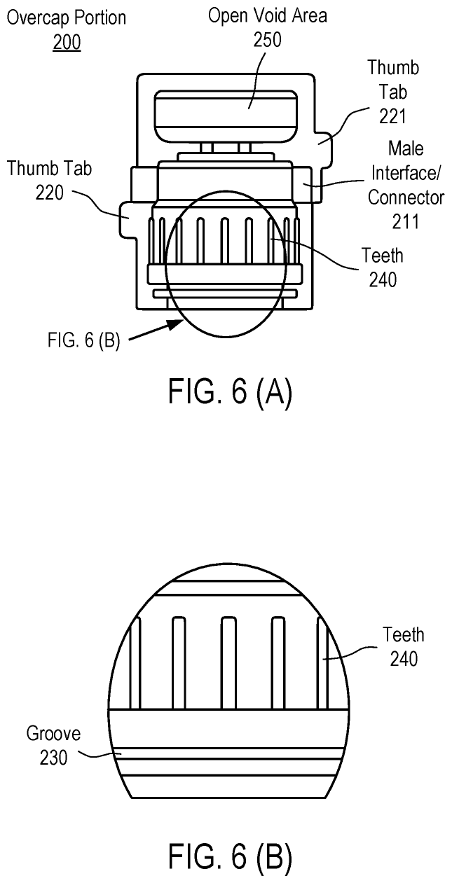

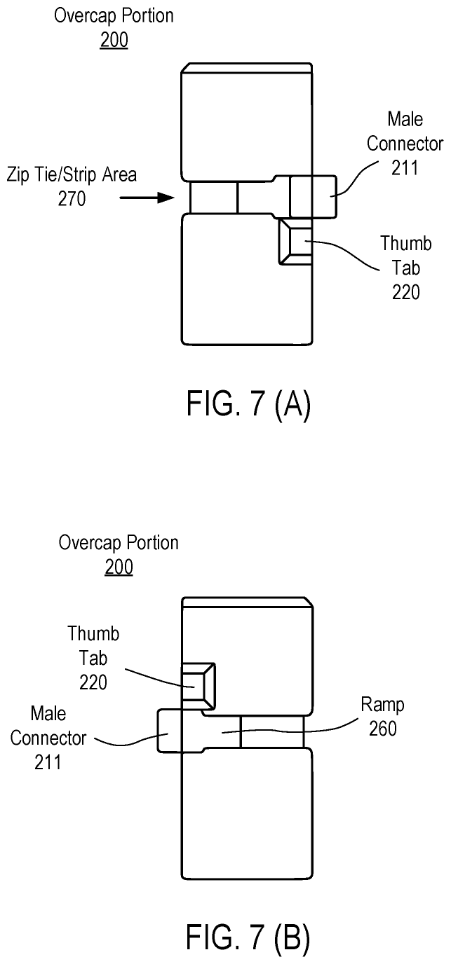

In one embodiment, protective overcaps described herein fit the cap for a 1 L and 2 L polycarbonate containers. Examples of such protective caps are shown in FIGS. 1-8.

The protective caps for a 1 L polycarbonate container are shown are shown FIGS. 1-4. Referring to FIGS. 1-4, overcap portion 100 is half of an overcap. Overcap portion 100 includes female interface/connector 110 and male interface/connector 111 that mate with corresponding male and female interfaces/connectors, respectively, of another half overcap portion to form a complete overcap. In one embodiment, the two overcap halves connect together. In one embodiment, the two overcap halves snap together to form the complete overcap. In another embodiment, the two overcap halves are held together with a tie (e.g., a zip tie, a cable tie, etc.), a snap-fit mechanism, a hook and eye connection, an adhesive tape, an adhesive (e.g., glue, epoxy, etc.), etc.

In one embodiment, the complete overcap is made from plastic or polycarbonate. However, the overcap is not limited to being these materials and may be made of other materials, such as, for example, but not limited to, aluminum or other metals.

An overcap that includes overcap portion 100 couples to the top of a container. In one embodiment, the container comprises a PET container or bottle. In one embodiment, the container comprises a 1 L polycarbonate container. Note that the embodiments described herein are not limited to use PET containers or 1 L polycarbonate containers and may be used with other types of containers.

In one embodiment, to facilitate the coupling between the overcap and the container, overcap portion 100 includes a groove 130 to receive a protrusion, such as a rim or lip of the container. In one embodiment, protrusion is resiliently-deformable when the cap is placed onto the container to enable the protrusion to enter groove 130. In another embodiment, the two overcap halves are placed around the container having the protrusion so that the protrusion is placed within groove 130 without having to be deformed.

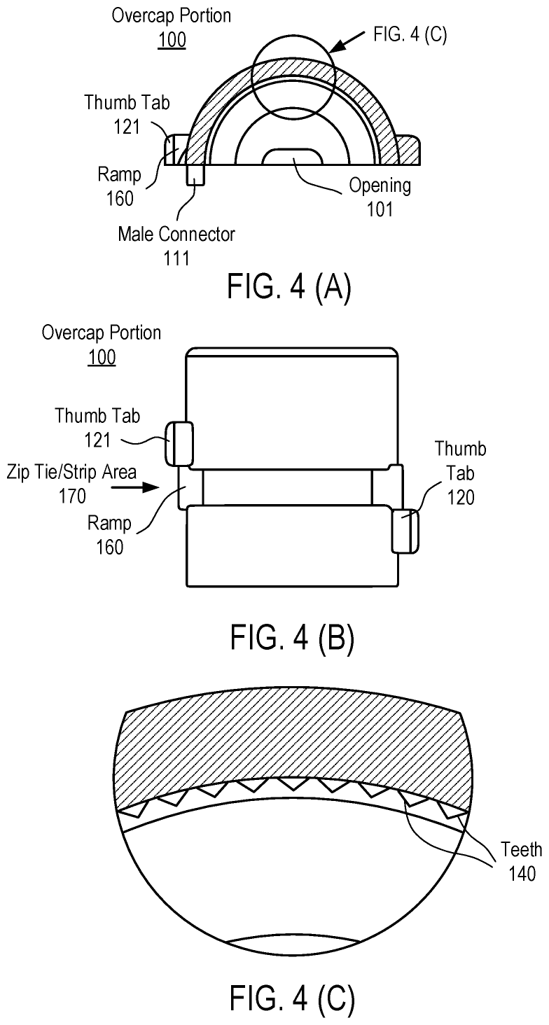

In one embodiment, overcap portion 100 also includes teeth (or grooves) 140 that mate or mesh with corresponding grooves in the top of the container to prevent the overcap from rotating (e.g., about the axis perpendicular to a closure of the container) when the overcap is coupled to the container. In one embodiment, the teeth are sized and shape to mate with the grooves that exist in the container. As shown in FIG. 4C, in one embodiment, teeth 140 are approximately in the shape of triangles. Note that the teeth 140 may have different shapes based on the grooves or teeth that are at the top of the container.

In one embodiment, overcap portion 100 includes an open or void area 150 within that is above an opening 101. In FIGS. 1-4, opening 101 when joined with a corresponding opening in an overcap portion to which it is joined is elliptical in shape; however, the resulting opening formed by opening 101 and a corresponding opening in an overcap portion to which it is mated may comprise any shape. The opening in the overcap formed in part by opening 101 allows feedlines or tubing to extend from the top of the container to be housed within the void area of the overcap formed in part by void area 150. In one embodiment, the size of the void area of the overcap is the minimum distance for packing the tubing that extends from the top of the container.

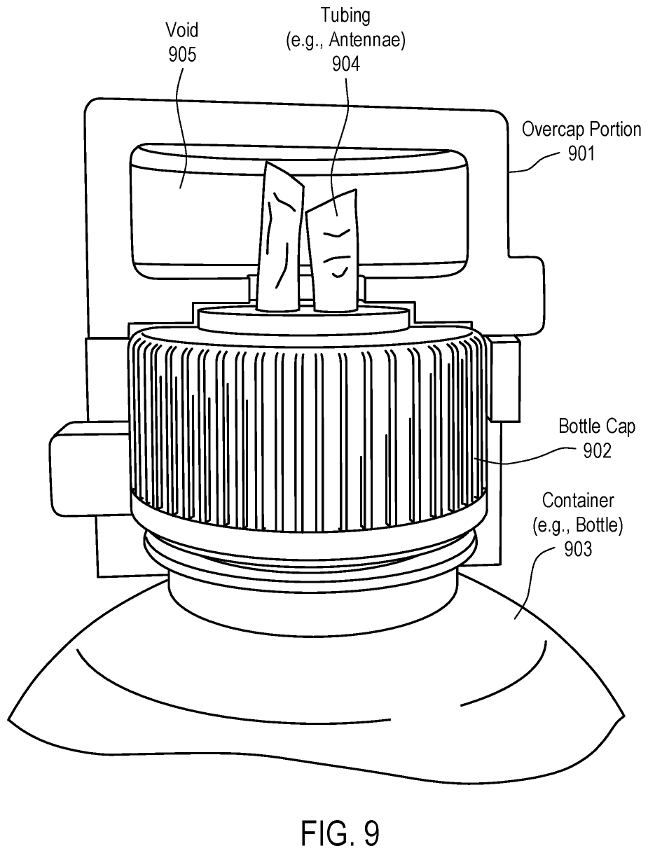

FIG. 9 is a section view of one embodiment of an overcap on a container. Referring to FIG. 9, overcap portion 901 is on cap 902 of container (e.g., bottle) 903. In one embodiment, container 903 comprises a storage container. In one embodiment, container 903 comprises a drug storage bottle (e.g., a closed-fill drug storage bottle, etc.). Overcap portion 901 includes void area 905 into which tubing (e.g., antennae) 904 rom cap 902 extend.

In one embodiment, overcap portion 100 includes tabs 120 and 121 (e.g., thumb tabs) that are used by an individual to snap the overcap off the container to which it is attached. The use of such tabs is well-known in the art.

In one embodiment, overcap portion 100 also includes a ramp 160 that is located in the mid-section of overcap portion 100. The purpose of ramp 160 is to maintain a separation between a tie (e.g., zip tie, plastic tie, etc.) and the overcap when a tie is wrapped around the overcap. The separation enables a tie cutter (e.g., knife, scissors, sharp edge, etc.) to be inserted between the tie and the overcap for removal of the tie. Thus, the size of ramp 160 may vary for different overcaps based on the size of the tie and the tie cutter to ensure that at least a portion of the tie cutter is able to get between the tie and the overcap so that the tie may be cut and removed from the overcap.

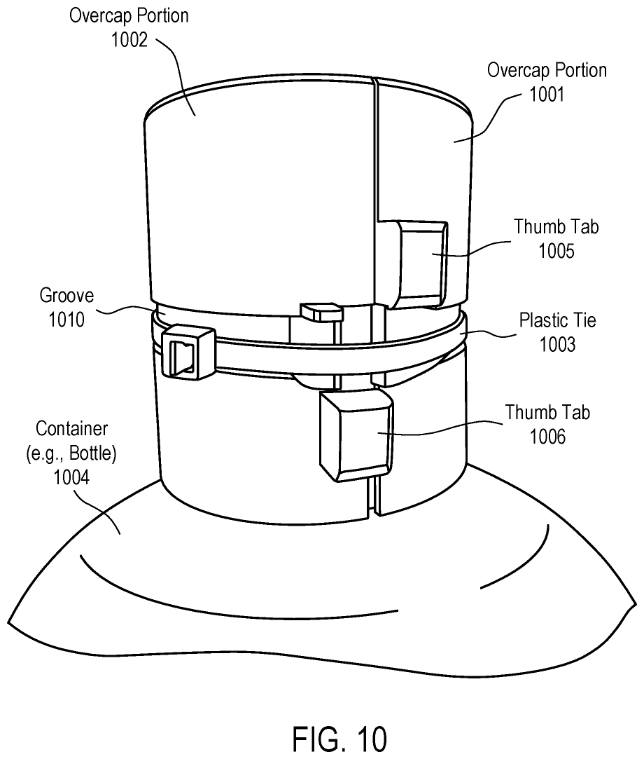

FIG. 10 illustrates one embodiment of an overcap on a container with a tie around the overcap. Referring to FIG. 10, overcap portions 1001 and 1002 are on and surround a cap of container (e.g., bottle) 1004. In one embodiment, container 1004 comprises a storage container. In one embodiment, container 1004 comprises a drug storage bottle (e.g., a closed-fill drug storage bottle, etc.). A plastic tie 1003 is positioned around overcap portions 1001 and 1002 in a groove 1010 that acts as a channel to maintain the location of plastic tie 1003. Overcap portions 1001 and 1002 are shown with thumb tabs 1005 and 1006, respectively.

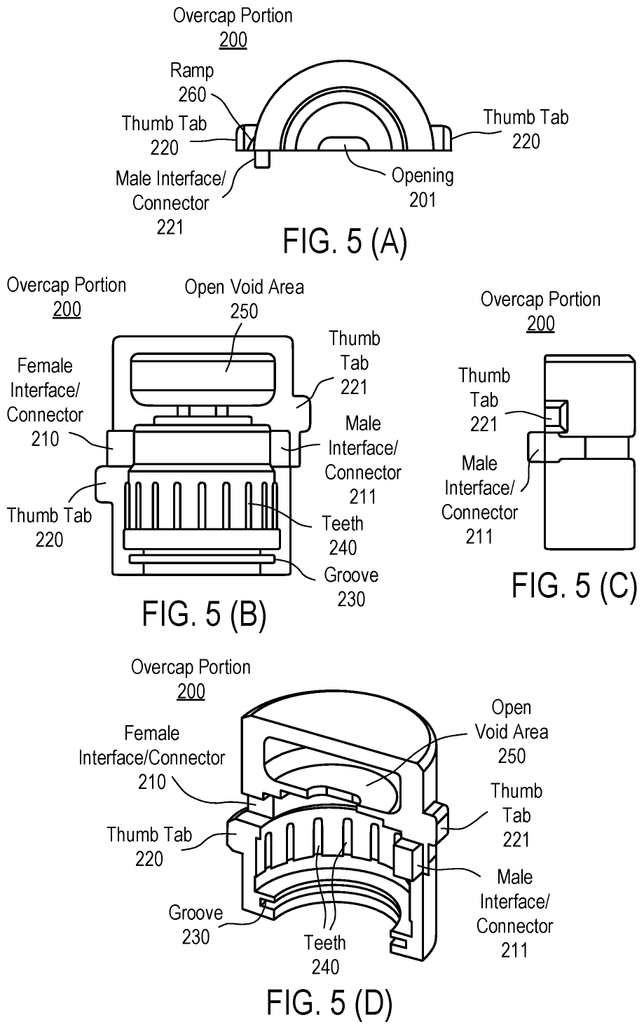

The protective caps for a 2 L Polyethylene Terephthalate Glycol (PETG) container are shown are shown FIGS. 5-8. Referring to FIGS. 5-8, overcap portion 200 is half of an overcap. Overcap portion 200 includes female interface/connector 210 and male interface/connector 211 that mate with corresponding male and female interfaces/connectors, respectively, of another half overcap portion to form a complete overcap. In one embodiment, the two overcap halves connect together. In one embodiment, the two overcap halves snap together to form the complete overcap. In another embodiment, the two overcap halves are held together with a tie (e.g., a zip tie, a cable tie, etc.), a snap-fit mechanism, a hook and eye connection, an adhesive tape, an adhesive (e.g., glue, epoxy, etc.), etc.

In one embodiment, the complete overcap is made from plastic or polycarbonate. However, the overcap is not limited to being these materials and may be made of other materials, such as, for example, but not limited to, aluminum or other metals.

An overcap that includes overcap portion 200 couples to the top of a container. In one embodiment, the container comprises a PET container or bottle. In one embodiment, the container comprises a 2 L polycarbonate container. Note that the embodiments described herein are not limited to use PET containers or 2 L polycarbonate containers and may be used with other types of containers.

In one embodiment, to facilitate the coupling between the overcap and the container, overcap portion 200 includes a groove 230 to receive a lip of the container. In one embodiment, protrusion is resiliently-deformable when the cap is placed onto the container to enable the protrusion to enter groove 230. In another embodiment, the two overcap halves are placed around the container having the protrusion so that the protrusion is placed within groove 230 without having to be deformed.

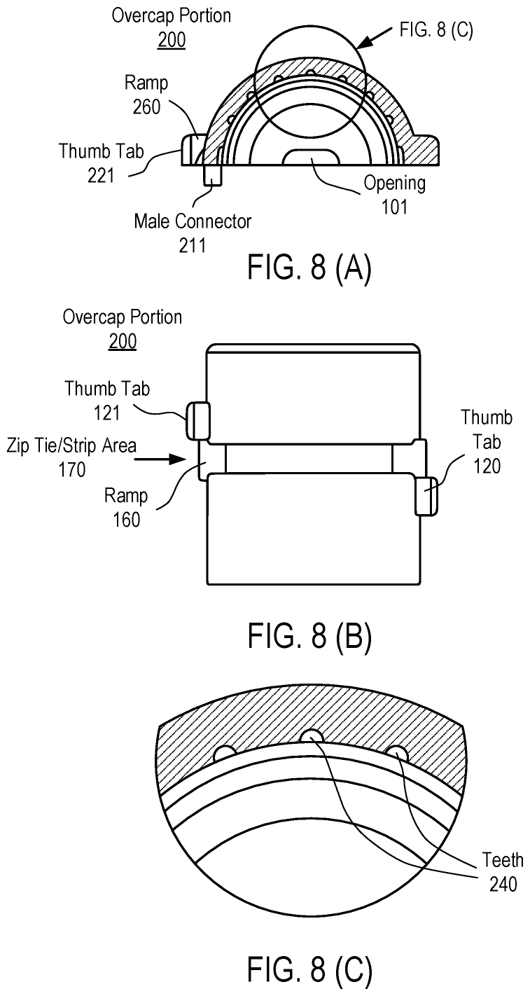

In one embodiment, overcap portion 200 also includes teeth (or grooves) 240 that mate or mesh with corresponding grooves in the top of the container to prevent the overcap from rotating (e.g., about the axis perpendicular to a closure of the container) when the overcap is coupled to the container. In one embodiment, the teeth are sized and shape to mate with the grooves that exist in the container. As shown in FIG. 8C, in one embodiment, teeth 240 are approximately in the shape of round circles. Note that the teeth 240 may have different shapes based on the grooves or teeth that are at the top of the container.

In one embodiment, overcap portion 200 includes an open or void area 250 within that is above an opening 201. In FIGS. 5-8, opening 201 when joined with a corresponding opening in an overcap portion to which it is joined is elliptical in shape; however, the resulting opening formed by opening 201 and a corresponding opening in an overcap portion to which it is mated may comprise any shape. The opening in the overcap formed in part by opening 201 allows feedlines tubing to extend from the top of the container to be housed within the void area of the overcap formed in part by void area 250. In one embodiment, the size of the void area of the overcap is the minimum distance for packing the tubing that extends from the top of the container.

In one embodiment, overcap portion 200 includes tabs 220 and 221 (e.g., thumb tabs) that are used by an individual to snap the overcap off the container to which it is attached. The use of such tabs is well-known in the art.

In one embodiment, overcap portion 200 also includes a ramp 260 that is located in the mid-section of overcap portion 200. The purpose of ramp 260 is to maintain a separation between a tie (e.g., zip tie, a cable tie, etc.) and the overcap when a tie is wrapped around the overcap. The separation enables a tie cutter (e.g., knife, scissors, sharp edge, etc.) to be inserted between the tie and the overcap for removal of the tie. Thus, the size of ramp 260 may vary for different overcaps based on the size of the tie and the tie cutter to ensure that at least a portion of the tie cutter is able to get between the tie and the overcap so that the tie may be cut and removed from the overcap.

There is a number of example embodiments described herein.

Example 1 is a cap for use with a container, the cap comprising: a groove to receive a protrusion of the storage container; and at least one compartment having an internal void with a volume sufficient to enclose antennae of the container.

Example 2 is the cap of example 1 that may optionally include that the protrusion of the container comprises a rim on a neck of the container.

Example 3 is the cap of examples 1-2 that may optionally include that the protrusion is resiliently-deformable when the cap is placed onto the container to enable the protrusion to enter the groove.

Example 4 is the cap of examples 1-3 that may optionally include that the protrusion is formed by a closure of the container.

Example 5 is the cap of examples 1-4 that may optionally include that the at least one compartment comprises two compartments that form the void.

Example 6 is the cap of examples 1-5 that may optionally include that the first compartment of the two compartments is defined by an inner side of the cap and a lower surface of one or more protrusions into the void and the second compartment of the two compartments is defined by an upper surface of the protrusions into the void and the inner sides and top of the cap.

Example 7 is the cap of examples 1-6 that may optionally include two or more sections adapted to reversibly engage with each other to form the cap.

Example 8 is the cap of examples 1-7 that may optionally include that the two or more sections are coupled together via a zip tie, a cable tie, a snap-fit mechanism, a hook and eye connection, and adhesive tape.

Example 9 is the cap of examples 1-8 that may optionally include a set of grooves, disposed within the void, to engage with the container to prevent the cap rotating about the axis perpendicular to a closure of the container.

Example 10 is the cap of examples 1-9 that may optionally include a plurality of lugs to assist with disconnecting the portions of the cap.

Example 11 is the cap of examples 1-10 that may optionally include that the storage container comprises a closed-fill fill storage container.

Example 12 is a cap for use with a container, the cap comprising: two or more sections adapted to reversibly engage with each other, wherein the two or more sections form a groove to receive a rim of the container and an internal void with a volume sufficient to enclose antennae of the container.

Example 13 is the cap of examples 12 that may optionally include that the rim is resiliently-deformable when the cap is placed onto the container to enable the rim to enter the groove.

Example 14 is the cap of examples 12-13 that may optionally include that the two or more sections comprises at least one compartment comprises two compartments that form the void.

Example 15 is the cap of examples 12-14 that may optionally include that the first compartment of the two compartments is defined by an inner side of the cap and a lower surface of one or more protrusions into the void and the second compartment of the two compartments is defined by an upper surface of the protrusions into the void and the inner sides and top of the cap.

Example 16 is the cap of examples 12-15 that may optionally include that the two or more sections are coupled together via a zip tie, a cable tie, a snap-fit mechanism, a hook and eye connection, and adhesive tape.

Example 17 is the cap of examples 12-16 that may optionally include a set of teeth, disposed within the void, to engage with the container to prevent the cap rotating about the axis perpendicular to a closure of the container.

Example 18 is the cap of examples 12-17 that may optionally include that teeth in the set of teeth mate with corresponding teeth on the container.

Example 19 is the cap of examples 12-18 that may optionally include that the teeth are separated from each other.

Example 20 is the cap of examples 12-19 that may optionally include a plurality of lugs to assist with disconnecting the portions of the cap.

Example 21 is a container and cap assembly, comprising a container and a cap according to any preceding examples 1-20.

Example 22 is the container and cap of example 21 that may optionally include that the container further comprises a drug substance.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

1. A cap for use with a container, the cap comprising:
a groove to receive a protrusion of the storage container; and
at least one compartment having an internal void with a volume sufficient to enclose antennae of the container.

2. The cap defined in claim 1 wherein the protrusion of the container comprises a rim on a neck of the container.

3. The cap defined in claim 2 wherein the protrusion is resiliently-deformable when the cap is placed onto the container to enable the protrusion to enter the groove.

4. The cap defined in claim 1 wherein the protrusion is formed by a closure of the container.

5. The cap defined in claim 1 wherein the at least one compartment comprises two compartments that form the void.

6. The cap defined in claim 5 wherein a first compartment of the two compartments is defined by an inner side of the cap and a lower surface of one or more protrusions into the void and a second compartment of the two compartments is defined by an upper surface of the protrusions into the void and the inner sides and top of the cap.

7. The cap defined in claim 1 further comprising two or more sections adapted to reversibly engage with each other to form the cap.

8. The cap defined in claim 7 wherein the two or more sections are coupled together via a zip tie, a cable tie, a snap-fit mechanism, a hook and eye connection, or adhesive tape.

9. The cap defined in claim 1 further comprising a set of grooves, disposed within the void, to engage with the container to prevent the cap rotating about the axis perpendicular to a closure of the container.

10. The cap defined in claim 1 further comprising a plurality of lugs to assist with disconnecting the portions of the cap.

11. The cap defined in claim 1 wherein the storage container comprises a closed-fill fill storage container.

12. A cap for use with a container, the cap comprising:
two or more sections adapted to reversibly engage with each other, wherein the two or more sections form a groove to receive a rim of the container and an internal void with a volume sufficient to enclose antennae of the container.

13. The cap defined in claim 12 wherein the rim is resiliently-deformable when the cap is placed onto the container to enable the rim to enter the groove.

14. The cap defined in claim 12 wherein the two or more sections comprises at least one compartment comprises two compartments that form the void.

15. The cap defined in claim 14 wherein a first compartment of the two compartments is defined by an inner side of the cap and a lower surface of one or more protrusions into the void and a second compartment of the two compartments is defined by an upper surface of the protrusions into the void and the inner sides and top of the cap.

16. The cap defined in claim 12 wherein the two or more sections are coupled together via a zip tie, a cable tie, a snap-fit mechanism, a hook and eye connection, or adhesive tape.

17. The cap defined in claim 12 further comprising a set of teeth, disposed within the void, to engage with the container to prevent the cap rotating about the axis perpendicular to a closure of the container.

18. The cap defined in claim 17 wherein teeth in the set of teeth mate with corresponding teeth on the container.

19. The cap defined in claim 18 wherein the teeth are separated from each other.

20. The cap defined in claim 12 further comprising a plurality of lugs to assist with disconnecting the portions of the cap.

21. A container and cap assembly, comprising a container and a cap according to claim 1.

22. The assembly according to claim 21, wherein the container further comprises a drug substance.

23. A container and cap assembly, comprising a container and a cap according to claim 12.
